(19) United States
(12) Patent Application Publication
(10) Pub. No.: US 2025/0226145 A1
(43) Pub. Date: Jul. 10, 2025

(54) DC-BIAS RESILIENT TRANSFORMER

(71) Applicants: PURDUE RESEARCH FOUNDATION, West Lafayette, IN (US); NATIONAL TECHNOLOGY & ENGINEERING SOLUTIONS OF SANDIA, LLC, ALBUQUERQUE, NM (US)

(72) Inventors: Scott David Sudhoff, West Lafayette, IN (US); Akhil Prasad, West Lafayette, IN (US); Todd Charles Monson, Albuquerque, NM (US); Ganapathi S Subramania, Albuquerque, NM (US)

(21) Appl. No.: 19/009,144

(22) Filed: Jan. 3, 2025

Related U.S. Application Data
(60) Provisional application No. 63/617,699, filed on Jan. 4, 2024.

(51) Int. Cl. H01F 27/28; H01F 27/24

(52) U.S. Cl. CPC H01F 27/28; H01F 27/24

(57) ABSTRACT

A transformer comprises a core including a first horizontal yoke, a second horizontal yoke, a first vertical leg extending from the first horizontal yoke to the second horizontal yoke, and a second vertical leg extending from the first horizontal yoke to the second horizontal yoke; a secondary winding wrapped around the first vertical leg and/or the second vertical leg; and a primary winding wrapped around the secondary winding, wherein the core includes a first portion formed of a first material having a first permeability and a second portion formed of a second material having a second permeability, wherein the second permeability is lower than the first permeability.

### CROSS-REFERENCE TO RELATED APPLICATIONS

This application claims priority to and the benefit of U.S. Provisional Application No. 63/617,699, filed on Jan. 4, 2024 and titled “DC-BIAS RESILIENT TRANSFORMER,” the entire contents of which are herein incorporated by reference for all purposes.

### STATEMENT REGARDING FEDERALLY SPONSORED RESEARCH OR DEVELOPMENT

This invention was made with government support under DE-AR0001405 awarded by the Department of Energy. The government has certain rights in the invention.

### TECHNICAL FIELD

This disclosure relates to the field of transformers. More particularly, this disclosure relates to metrics and strategies for the design of DC bias resilient transformers and to the DC bias resilient transformers themselves.

### BACKGROUND

Transformers, with their ability to change voltage levels and thereby facilitate efficient transfer of electric power, form an integral part of the electric power grid. However, comparative examples of transformers remain extremely vulnerable. The average age of large power transformers in the United States exceeds 40 years. Due to increasing demand and the changing nature of the electrical grid, many of these comparative transformers are operating under stresses that were never anticipated. Solar flare activity, for example, causes transient fluctuations in the geomagnetic field, which induce earth surface potential (ESP) that can be 3 to 6 volts/km or higher. The ESP generates geomagnetically induced currents (GICs) that complete their path through transformer grounded neutral connections. These GICs could have amplitudes of up to 200 A and a fundamental frequency range of 0.0001 to 0.1 Hz and hence appear as quasi-dc currents in the transformer conductors. Quasi-dc currents can also result from electro-magnetic pulses (EMPs).

The existence of such quasi-de currents causes multiple problems in the power grid. The GIC flowing through the transformer windings causes half-cycle saturation due to the dc current, which quickly saturates the highly permeable transformer core. This half-cycle saturation causes a loss of odd half-wave symmetry leading to even harmonics. Indeed, because of the nonlinear magnetics, a rich spectrum of both odd and even harmonics is produced, potentially causing insulation failure and even melting of copper conductors. Further, the reduction of the transformers magnetizing inductance will cause the transformer to appear as a significant inductive load and increase the transformer volt-ampere reactive (VAR) consumption.

### SUMMARY

These and other problems may be overcome by transformers having configurations as set forth herein. Thus, the present disclosure provides for transformer architectures that are resilient to dc bias.

According to one aspect of the present disclosure, a transformer is provided. The transformer comprises a core including a first horizontal yoke, a second horizontal yoke, a first vertical leg extending from the first horizontal yoke to the second horizontal yoke, and a second vertical leg extending from the first horizontal yoke to the second horizontal yoke; a secondary winding wrapped around the first vertical leg and/or the second vertical leg; and a primary winding wrapped around the secondary winding, wherein the core includes a first portion formed of a first material having a first permeability and a second portion formed of a second material having a second permeability, wherein the second permeability is lower than the first permeability.

According to another aspect of the present disclosure, a three-phase transformer is provided. The transformer comprises a core including a first horizontal yoke, a second horizontal yoke, a first vertical end leg extending from the first horizontal yoke to the second horizontal yoke, a second vertical end leg extending from the first horizontal yoke to the second horizontal yoke, a first vertical interior leg extending from the first horizontal yoke to the second horizontal yoke, a second vertical interior leg extending from the first horizontal yoke to the second horizontal yoke, and a third vertical interior leg extending from the first horizontal yoke to the second horizontal yoke; a first-phase secondary winding wrapped around the first vertical interior leg; a first-phase primary winding wrapped around the first-phase secondary winding; a second-phase secondary winding wrapped around the second vertical interior leg; a second-phase primary winding wrapped around the second-phase secondary winding; a third-phase secondary winding wrapped around the third vertical interior leg; and a third-phase primary winding wrapped around the third-phase secondary winding; wherein the core includes a first portion formed of a first material having a first permeability and a second portion formed of a second material having a second permeability, wherein the second permeability is lower than the first permeability.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be understood that the drawings are not to scale unless otherwise indicated.

FIG. 1 illustrates a graph of primary current versus time.

FIG. 2A illustrates an example of a transformer cross-section according to a comparative example.

FIG. 2B illustrates another example of a transformer cross-section according to a comparative example.

FIG. 3 illustrates an example of an electrical equivalent circuit for a transformer.

FIG. 4 illustrates an example of a magnetic equivalent circuit for the transformer of FIGS. 2A and 2B.

FIG. 5 illustrates a graph of a Pareto front according to a comparative example.

FIG. 6 illustrates graphs of a primary current response according to a comparative example.

FIG. 7 illustrates an example of a transformer cross-section according to various examples of the present disclosure.

FIG. 8 illustrates an example of a magnetic equivalent circuit for the transformer of FIG. 7.

FIG. 9 illustrates a graph of a Pareto front comparison.

FIG. 10 illustrates graphs of a primary current response according to various aspects of the present disclosure.

FIG. 11 illustrates an example of a transformer cross-section according to various aspects of the present disclosure.

FIG. 12 illustrates an example of a transformer cross-section according to various aspects of the present disclosure.

FIG. 13A illustrates an example of a magnetic equivalent circuit for the transformer of FIG. 11.

FIG. 13B illustrates an example of a magnetic equivalent circuit for the transformer of FIG. 12.

FIG. 14 illustrates a graph of a Pareto front comparison.

FIG. 15 illustrates an example of a transformer cross-section according to various aspects of the present disclosure.

FIG. 16 illustrates an example of a transformer cross-section according to various aspects of the present disclosure.

FIG. 17 illustrates graphs of a primary current response according to various aspects of the present disclosure.

FIG. 18 illustrates graphs of a primary current response according to various aspects of the present disclosure.

FIG. 19 illustrates graphs of a primary current response according to various aspects of the present disclosure.

FIG. 20 illustrates an example of a transformer cross-section according to various aspects of the present disclosure.

FIG. 21 illustrates an example of a transformer cross-section according to various aspects of the present disclosure.

FIG. 22 illustrates an example of a transformer design process flow according to various aspects of the present disclosure.

FIG. 23 illustrates an example no-load test under dc bias according to various aspects of the present disclosure.

FIG. 24 illustrates a graph of efficiency versus dc bias current according to various aspects of the present disclosure.

FIG. 25 illustrates a graph of primary current distortion versus de current bias at full load according to various aspects of the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration. Moreover, discussion of “horizontal” or “vertical” features may in some implementations be relative to the earth's surface; however, in other implementations a transformer may be installed in a different orientation such that a “horizontal” feature is not necessarily parallel to the earth's surface. Thus, more generally “vertical” may refer to the extending direction of transformer core components (i.e., transformer core legs) around which windings are wound, whereas “horizontal” may refer to the direction perpendicular to vertical.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

Geomagnetic disturbances (GMDs) give rise to GICs on the earth's surface that find their way into power systems via grounded transformer neutrals. The quasi-de nature of the GICs results in half-cycle saturation of the power grid transformers which in turn results in transformer failure, life reduction, and other adverse effects. Therefore, there exists a need for transformers that are more resilient to de excitation. The present disclosure sets forth dc immunity metrics for transformers. Furthermore, the present disclosure sets forth a transformer architecture and a design methodology that employs the de immunity metrics to provide a transformer that is resilient to dc excitation.

Power transformer saturation reduces the apparent impedance seen by relays, and unnecessary tripping may occur if this apparent impedance is within the operating zone of the relay. Overcurrent ground relays could also malfunction due to the increased zero-sequence current caused by transformer saturation. It has been found that the effects of GIC vary with the transformer configuration with the three-legged core configuration being the most resilient. During half-cycle saturation, the leakage flux links with multiple adjacent structural members resulting in excessive heat loss. DC bias and GIC related heating of the transformer core and its structural members may occur. One of the concerns resulting from this heating is that winding insulation adjacent to the structural member may be heated excessively, resulting in thermal degradation of the insulation. Another concern is that an intense, local heat source might rapidly decompose adjacent insulation and generate a free gas bubble in the oil whose existence and mobility could cause or contribute to a dielectric breakdown.

For example, at various substations within the Kola power grid in Russia between 1969 and 1972, it was observed that the neutral currents were rich in third harmonic component. Moreover, it was reported that the GIC results in the saturation of auto-transformer core and harmonic boost which could cause relay operation and/or transformer heating. In the high voltage power grid in China, it was noted that the GIC reached a peak value of 75.5 A at the Ling ‘Ao nuclear power plant transformer during a GMD event in 2004. It was observed that the frequency of these GICs varied between 0.01-0.0001 Hz. In 2006, peak GIC values of up to 13 A and 16.6 A were measured at Shanghe substation and Ling ‘Ao nuclear power plant.

The presence of GIC in transformer windings decreases the lifetime of the transformer and hence there needs to be more resilience to de current. To calculate how resilient a transformer is to de current, metrics are needed. In the present disclosure such dc current immunity metrics are set forth and used to design a dc current tolerant transformer. Time-stepping finite element analysis (FEA) is used to validate the results.

The present disclosure presents transformers and systems and methods of designing and/or manufacturing transformers. In some examples, the transformers involve a modified transformer core having a low permeability core within a high permeability core. In some examples, the transformers may be designed based on a genetic algorithm-based multi-objective optimization, which may include the calculation of a fitness function which encapsulates all transformer metrics of interest as well as all constraints.

While the present disclosure describes examples of single-phase core-type transformer architectures, the present disclosure is not so limited. The systems, metrics, methods, etc. described herein may be applied to other transformer architectures, including the three-phase case and/or the shell-type architecture.

### DC Current Immunity Metrics

The present disclosure describes metrics that may be used in transformer design to address robustness of transformers with respect to dc bias currents. In order to formulate these metrics, and for ease of explanation, these metrics will be described from the perspective of a single-phase transformer in which the secondary is open circuited. However, this is merely by way of example and other architectures fall within the scope of the present disclosure.

At the outset, nomenclature will be defined. If x represents some quantity, it may be decomposed into a constant (dc) term x_{dc} and an ac term x_{ac}, which may not be sinusoidal in general but which has a zero time-average value. This may be described according to the following expression (1).

$$x = {x}_{dc} + {x}_{ac} \qquad ( 1 )$$

Moreover, it is assumed that using FEA, a magnetic equivalent circuit (MEC), or some other method, the no-load anhysteretic relationship between the primary current i and flux linkage λ may be expressed according to the following expressions (2) and (3). While expressions (2) and (3) contain identical information, the roles of input and output are transposed between the two forms.

$${λ}_{p} = f ( {i}_{p} ) \qquad ( 2 )$$

$${i}_{p} = g ( {λ}_{p} ) \qquad ( 3 )$$

Considering the operation of the transformer, from Ohm's and Faraday's laws the voltage v may be expressed according to the following expression (4).

$${v}_{p} = {r}_{p} {i}_{p} + \frac{d {λ}_{p}}{dt} \qquad ( 4 )$$

It follows that the ac components of these variables may be expressed according to the following expression (5).

$${v}_{p , ac} = {r}_{p , ac} {i}_{p , ac} + \frac{d {λ}_{p , ac}}{dt} \qquad ( 5 )$$

Because the primary resistance rₚ is typically very small, expression (5) suggests that the ac component of the primary flux linkage is not greatly affected by dc offsets or the primary current. Thus, the ac component of the flux linkage may be estimated according to the following expression (6), where the initial condition is found such that the resulting flux linkage has no dc component.

$${λ}_{p , ac} = {\int }_{0}^{t} {v}_{p , ac} d τ + {λ}_{p , ac} ( 0 ) \qquad ( 6 )$$

In expression (6), and throughout the present disclosure, time t=0 is taken to be at some point after steady state has been achieved. For example, if

$$v = \sqrt{2} {V}_{p} cos ( {ω}_{e} t + {ϕ}_{p} ) \qquad ( 7 )$$

$$then$$

$${λ}_{p , ac} = {λ}_{p , acpk} sin ( {ω}_{e} t + {ϕ}_{p} ) \qquad ( 8 )$$

$$where {λ}_{p , acpk} = \sqrt{2} {V}_{p} / {ω}_{e} .$$

Supposing that it is desired to limit the peak primary current to i_{p,pka}, then the corresponding peak allowed value of the primary flux linkage may be computed according to the following expression (9).

$${λ}_{p , pka} = f ( {i}_{p , pka} ) \qquad ( 9 )$$

Because the ac component of the ac flux linkage is known, it follows that the corresponding dc value of flux linkage may be expressed according to the following expression (10).

$${λ}_{p , dc} = {λ}_{p , pka} - {λ}_{p , acpk} \qquad ( 10 )$$

In expression (10), λ_{p,acpk} is the peak value of the ac component of the flux linkage waveform, which may be found from expression (6). The dc component of the current for this condition may be expressed according to the following expression (11).

$${i}_{p , dc} = \frac{1}{T} {\int }_{0}^{t} g ( {λ}_{p , dc} + {λ}_{p , ac} ) dt \qquad ( 11 )$$

The current i_{p,dc} is the dc bias current the transformer can tolerate with an ac flux linkage waveform λ_{p,ac} so that the steady-state peak primary current remains below i_{p,pka}. This primary side dc current can be used either as a constraint or as a design objective to be maximized.

An illustrative example is presented, supposing that the secondary is open circuited, and the primary flux linkage and primary current are related by expression (2), where the following expression (12) holds.

$$f ( {i}_{p} ) = {L}_{l} {i}_{p} + \frac{{L}_{m} {λ}_{sat} {i}_{p}}{{λ}_{sat} + {L}_{m} \vert {i}_{p} \vert} \qquad ( 12 )$$

This characteristic qualitatively appears correct, but the saturation is “softer” than is typical. It is used here because it is an analytically invertible form, to facilitate a straightforward example for explanatory purposes. The parameters Lₗ, Lₘ, and λₛₐₜ may be loosely interpreted as the leakage inductance, magnetizing inductance, and saturated magnetizing flux linkage, respectively. From expression (12), the following expression (13) may be shown.

$${i}_{p} = g ( {λ}_{p} ) = \frac{( {L}_{m} {λ}_{p} - {L}_{p} {λ}_{sat} δ ) + δ \sqrt{{( {L}_{m} {λ}_{p} - {λ}_{p} {λ}_{sat} δ )}^{2} + 4 {λ}_{p} δ {L}_{l} {L}_{m} {λ}_{sat}}}{2 {L}_{l} {L}_{m}} \qquad ( 13 )$$

Above, δ=sgn(λₚ) and Lₚ=Lₗ+Lₘ. For this example, the assumed parameters are Lₗ=1.15 mH, Lₘ=2.29 H, and λₛₐₜ=1.17 Vs, which are loosely based on a 208 V to 120V 5 kVA transformer. These parameters have been selected by way of example for ease of comparability with various examples which will be discussed in more detail below.

For this system, using the rated primary-side voltage, λ_{p,acpk}=0.780 Vs may be obtained. If the acceptable value of open-circuit peak primary current is taken to be 1 pu (where here per unit is defined by the peak of the waveform), i_{p,pka}=34.0 A may be obtained and, from expression (9), λ_{p,pka}=1.19 Vs. From expression (10), λ_{p,dc}=0.412 Vs may be obtained. Using this value in expressions (8) and (11), i_{p,dc}=3.96 A may be obtained as the allowed de current.

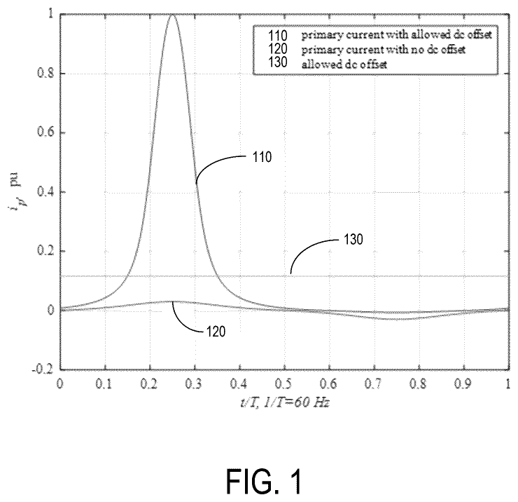

FIG. 1 illustrates this situation. Therein, trace 120 labeled “primary current with no dc offset” represents the normal no-load primary current without dc offset. The waveform is symmetrical. Adding a dc component to the voltage to create a dc offset (trace 130 labeled “allowed dc offset”) causes half-cycle saturation such that the peak primary current is 1 pu (again, per unitized such that the peak is 1 pu). While this level of saturation is survivable, it may have deleterious effects. Together expressions (9)-(11) provide a process to determine the acceptable dc current for which the peak no-load primary current (essentially, the magnetizing current) is below the allowed value.

An alternate formulation of the problem is based on the rms value of the primary current rather than being based on the peak value. The rms of the primary current may be expressed according to the following expression (14).

$${i}_{{p}_{rmsa}}^{2} = \frac{1}{T} {\int }_{0}^{T} {g}^{2} ( {λ}_{p , dc} + {λ}_{p , ac} ) dt \qquad ( 14 )$$

For an allowed rms value of the primary current i_{p,rmsa}, and an ac flux linkage waveform λ_{p,ac}, expression (14) may be solved for the corresponding value of the de component of the primary flux linkage λ_{p,dc} which may then be substituted into expression (11) to calculate the corresponding value of dc bias primary current i_{p,dc}.

Returning to the previous example, in which the peak no-load primary current was limited to 1 pu (peak base), the corresponding value of allowed primary no-load rms current i_{p,rmsa}=9.39 A, or about 0.389 pu (rms base).

### Comparative Transformer Design

To illustrate the resilience of transformers according to the present disclosure with respect to do bias current, a comparative example is considered. Although the concern over resiliency is often focused on transmission-scale transformers, this comparison will be made with regard to low-power transformers to illustrate the principles involved.

In particular, the design of a single-phase, 60 Hz, 5 kVA 208 V to 120 V transformer has been conducted. Some design constraints are that (i) the no-load secondary voltage should be within 2% of the rated value, (ii) the no-load primary current should be less than 10% of the base current (although in practice it may not be close to this), (iii) the regulation should be less than 5%, and (iv) the peak value of inrush current should be equal to (i.e., within 5% of) 2\sqrt{2} times the rated rms primary current. The design objectives are to minimize electromagnetic mass and aggregate loss, where the aggregate loss is a weighted loss assuming 10% of the time at no-load, 40% of the time at resistive half-load, and 50% of the time at full-load.

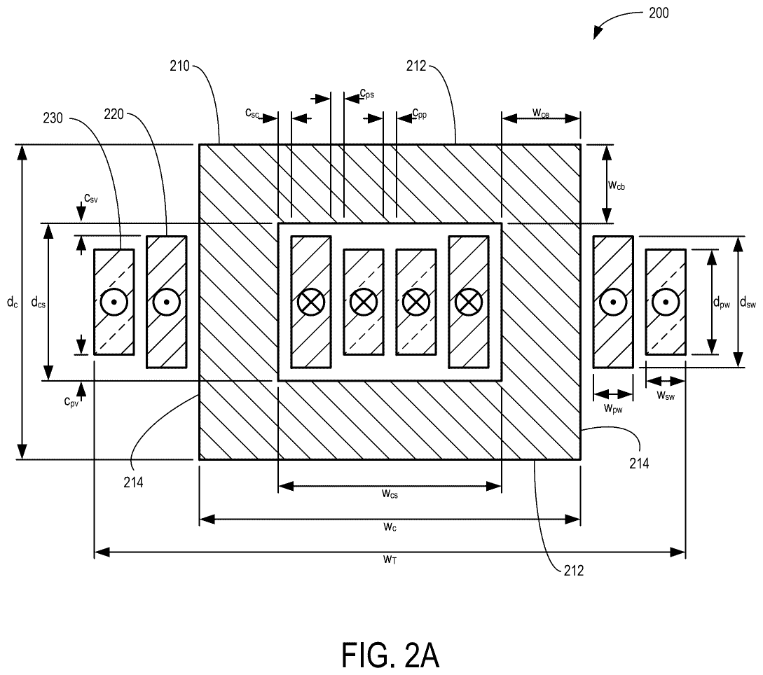

The transformer geometry of this comparative example is illustrated in FIGS. 2A and 2B. In particular, FIG. 2A illustrates a cross-section of a transformer 200, whereas FIG. 2B illustrates an end-leg cross-section of the transformer 200. For ease of explanation, only one end-leg cross-section is shown in FIG. 2B, corresponding to one-half of the transformer 200. For purposes of illustration, the transformer 200 is a single-phase core-type transformer. However, as noted above, the present disclosure is also applicable to multi-phase (e.g., three-phase) transformers, and is also applicable to other transformer architectures (e.g., shell-type). As illustrated in FIGS. 2A and 2B, the transformer 200 includes a core 210 comprising two horizontal yokes 212 and two vertical legs 214. A secondary winding 220 is wrapped around each leg 214 of the core 210, and a primary winding 230 is wrapped around the secondary winding 220. FIGS. 2A and 2B are further annotated with the widths w, depths d, lengths l, clearances c, and radii of curvature r of various components of the core 210, the secondary winding 220, the primary winding 230, and the overall transformer 200.

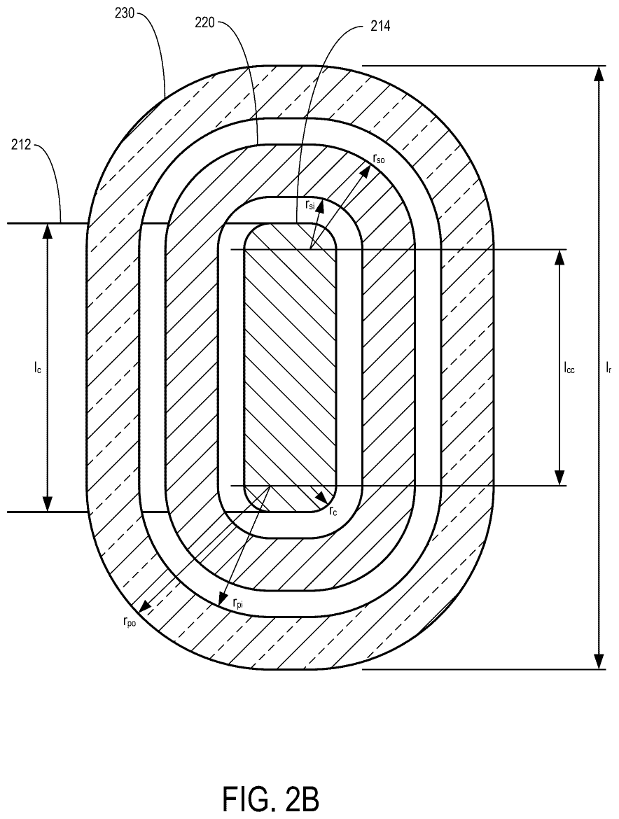

FIG. 3 illustrates an example electrical equivalent circuit of a single-phase transformer, which may be the transformer 200 described above with regard to FIGS. 2A and 2B or any of the transformers described below. In general, the transformer operates to convert a primary voltage Vₚ to a secondary voltage Vₛ, which may be higher than the primary voltage Vₚ (in the case of a step-up transformer) or lower than the primary voltage Vₚ (in the case of a step-down transformer). The primary and secondary coils are wound around a core, for example as illustrated in FIGS. 2A and 2B. In an AC system, the primary voltage Vₚ causes a time-varying primary current to flow through the primary coil, which induces a time-varying magnetic flux in the core material. The flux in the core material in turn causes a time-varying secondary current to flow through the secondary coil, resulting in the secondary voltage Vₛ. The ratio between the voltages is proportional to the ratio between the number of turns in the primary and secondary coils.

In an electrical power grid implementation, the transformer may be used to convert electricity between a transmission voltage (i.e., a voltage at which the electricity is transferred, generally over long distances) and a local voltage (i.e., a voltage at which the electricity is used). To avoid transmission losses when transmitting electricity over long distances, the transmission voltage is typically much higher than the local voltage. In such implementations, a three-phase transformer is generally used rather than the single-phase transformer of FIG. 3; however, the operation is analogous. In operation, the primary voltage Vₚ may be provided from an electricity generation source (e.g., a power plant) and transmitted across a distribution network. At the transformer, the primary voltage Vₚ induces a secondary voltage Vₛ that may be output from the transformer.

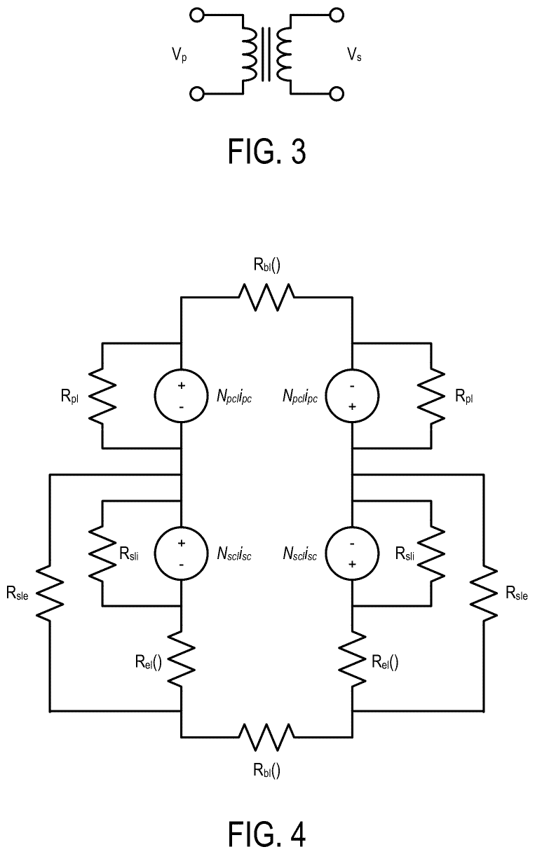

For purposes of expositional efficiency, the main analysis is a nonlinear magnetic equivalent circuit. The magnetic equivalent circuit used in the design of the transformer is illustrated in FIG. 4. Specifications are listed in Table 1.

TABLE 1
Design Specifications

| Specification | Symbol | Value | |
|---|---|---|---|
| Rated apparent power | S | 5 | kVA |
| Fundamental frequency | f | 60 | Hz |
| Fundamental frequency | ω | 377 | rad/s |
| Nominal primary voltage | V_{pb} | 208 | V |
| Nominal secondary voltage | V_{sb} | 120 | V |
| Nominal primary current | I_{pb} | 24.0 | A |
| Minimum no-load secondary voltage | 0.98V_{sb} | 118 | V |
| Maximum no-load secondary voltage | 1.02V_{sb} | 122 | V |
| Maximum allowed no-load primary | 0.1I_{pb} | 2.40 | A |
| current | | | |
| Maximum allowed regulation | χₘₓₐ | 0.05 | |
| Maximum instantaneous primary inrush | 2\sqrt{2}I_{pb} | 68.0 | A |
| current | | | |
| Worse case instantaneous primary | 2\sqrt{2}V_{pb}/ωₑ | 1.56 | Wb |
| flux linkage | | | |
| Maximum allowed aggregate loss | Pₗₘₓₐ | 150 | W |
| Maximum allowed total electromagnetic | M_{Tmxa} | 40 | kg |
| mass | | | |
| Maximum allowed length | l_{Tmxa} | 1 | m |
| Maximum allowed width | w_{Tmxa} | 1 | m |
| Maximum allowed height | d_{Tmxa} | 1 | m |

| | | |
|---|---|---|
| Op. point loss weights | w | [0.1 0.4 0.5] |

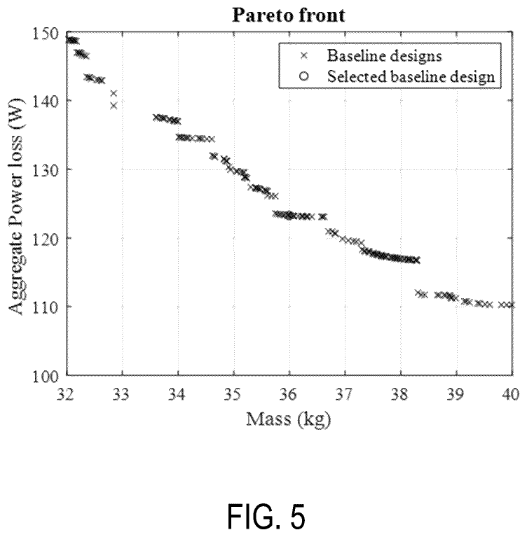

FIG. 5 illustrates the Pareto-optimal front for the transformer 200. The selected design is referred to as Design 90, so named because it was the 90^{th} design in the order of increasing mass along the Pareto-optimal front. Several parameters of this design are listed in Table 2. Note that the two primary coils are connected in parallel, as are the two secondary coils. This is the case throughout this disclosure solely for purposes of explanation. However, transformers in accordance with the present disclosure may include coils connected in parallel, series, or both. For example, the primary coils may be connected in series and the secondary coils may be connected in parallel, the primary coils may be connected in parallel and the secondary coils may be connected in series, or both the primary and secondary coils may be connected in series.

TABLE 2
Selected Parameters for Design 90

| Transformer Parameter | Value | |
|---|---|---|
| Total mass | 36 | kg |
| Encapsulating volume | 4.41 | |
| Core material | M19 | |
| Primary winding wire gauge | 11 | |
| Primary winding conductor in hand | 1 | |
| Primary number of turns per coil | 166 | |
| Primary resistance | 0.158 | Ω |
| Primary leakage inductance | 0.729 | mH |
| Secondary winding wire gauge | 15 | |
| Secondary winding conductors in hand | 4 | |
| Secondary number of turns per coil | 94 | |
| Secondary resistance | 45.3 | mΩ |
| Secondary leakage inductance | 34.7 | μH |
| No-load magnetizing inductance | 3.38 | H |
| Transformer regulation | 4.93% | |
| No-load magnetizing current (rms) | 0.226 | A |

| | |
|---|---|
| Half-load efficiency | 97.0% |
| Full-load efficiency | 96.1% |

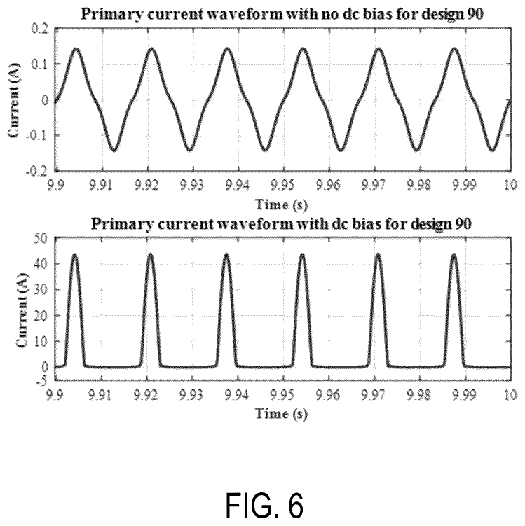

In this comparative design, no provision has been made to address the impact of dc current. FIG. 6 illustrates the case where the transformer is open circuited, and a voltage according to the following expression (15) is applied to the transformer.

$${v}_{p , ac} = 208 \sqrt{2} cos ( {ω}_{e} t ) + {r}_{p} {i}_{p , dc} \qquad ( 15 )$$

In this expression, rₚ is the primary winding resistance, and i_{p,dc} is the dc component of the current which must be tolerated.

A time-stepping FEA study was conducted using Ansys Electronics Desktop 2021, wherein a 2D model of Design 90's primary winding was excited with the voltage waveform described in expression (15). The secondary was open-circuited. The results are illustrated in FIG. 6. Therein, in the upper trace, the de term in expression (15) is not included and the peak magnetizing current is less than 150 mA; in the lower trace the de term is included with i_{p,dc}=7 A, resulting in a peak current of over 40 A. Even this modest de excitation results in a notable difference. To address this, the present disclosure presents various configurations for increasing the resilience of the transformer 200.

### Impact of DC Bias Immunity on Transformer Design-Gapped Configuration

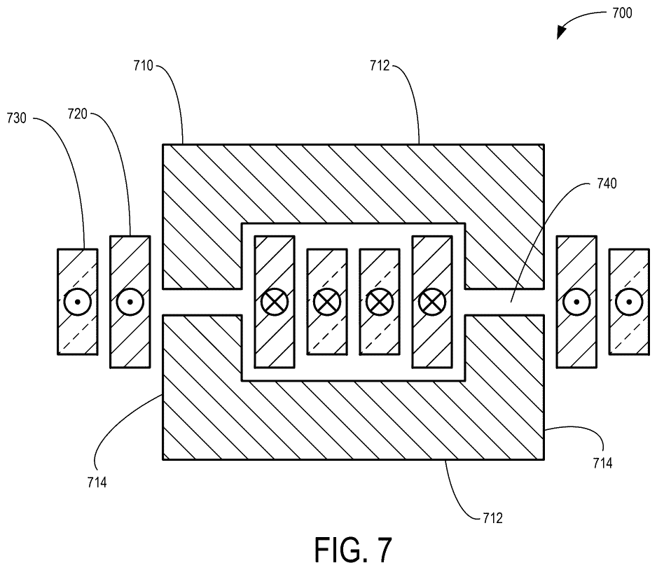

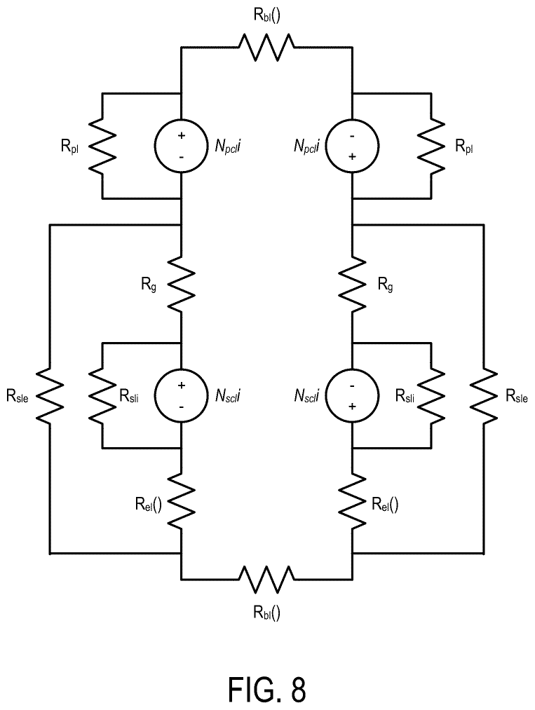

One method to increase the dc bias resiliency of a transformer is to utilize a gapped core. One example of such an approach is illustrated in FIG. 7. In this approach, the transformer core is divided into two cores separated by an air gap. The air gap increases the reluctance in the path of the dc and magnetizing flux thereby making the transformer less susceptible to half-cycle saturation at the expense of decreasing transformer magnetizing inductance. As illustrated, the transformer 700 includes a core 710 comprising two horizontal yokes 712 and two vertical legs 714. A secondary winding 720 is wrapped around each leg 714 of the core 710, and a primary winding 730 is wrapped around the secondary winding 720. Each leg includes a gap 740. FIG. 8 illustrates the magnetic equivalent circuit of the transformer 700. Therein the reluctance term R_{g} represents the reluctance of the air gap 740.

The transformer 700 may be studied for a single-phase, 60 Hz, 5 kVA, 208 V to 120 V transformer, similar to the analysis performed above for the transformer 200. In addition to the constraints discussed above, one additional constraint that is introduced here is that the peak primary current, under dc bias condition of 7 A (20% of the rated peak primary current), is equal to (i.e., within 5% of) half the rated peak primary current, equivalent to 17.0 A in this example. The constraint on maximum mass was removed to ensure that viable designs were found.

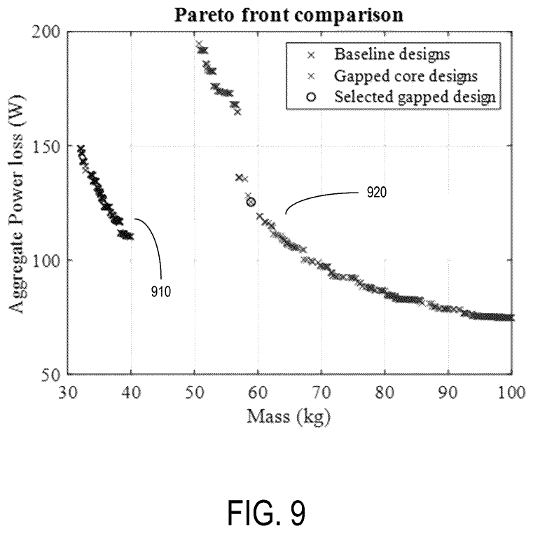

FIG. 9 compares the Pareto fronts of the gapped design study and the comparative example design study. It can be observed that the baseline designs 910, without the dc bias constraint, exhibit a much lower mass for the same aggregate power loss compared to the comparative designs 920. This is because, in order to satisfy the dc bias constraint, the design algorithm increases the magnetic cross-section to compensate, to some extent, for the increase in reluctance due to the gap. Another distinction between the designs is that the core of most of the comparative example designs utilized M19 steel and a small percentage were made of M43 steel, whereas the gapped core designs utilized M19, M43, and M47 steel. One of the reasons behind this is the lower relative permeability of M43 and M47 steel compared to M19 steel thereby providing a higher reluctance path to the dc component of the magnetizing flux. Note the permeability was a function of the specific steels considered, not inherently their loss classification.

Design 248 of the gapped core designs is indicated with a black circle, and its selected parameters are listed in Table 3. A characteristic of interest for transformers is the no-load current. It can be seen by comparing the selected comparative example and gapped core designs that the gapped core design has a much higher no-load current (2.39 A rms as opposed to 226 mA rms). This is primarily because of the air gap reluctance.

TABLE 3
Parameters for Gapped Core Design 248

| Transformer Parameter | Value | |
|---|---|---|
| Total mass | 58.9 | kg |
| Encapsulating volume | 7.41 | |
| Core material | M19 | |
| Primary winding wire gauge | 15 | |
| Primary winding conductor in hand | 3 | |
| Primary number of turns per coil | 162 | |
| Primary resistance | 0.154 | Ω |
| Primary leakage inductance | 0.733 | mH |
| Secondary winding wire gauge | 15 | |
| Secondary winding conductors in hand | 4 | |
| Secondary number of turns per coil | 92 | |
| Secondary resistance | 55.5 | mΩ |
| Secondary leakage inductance | 13.2 | μH |
| No-load magnetizing inductance | 0.230 | H |
| Transformer regulation | 4.98% | |
| No-load magnetizing current (rms) | 2.39 | A |

| | |
|---|---|
| Half-load efficiency | 97.1% |
| Full-load efficiency | 95.9% |

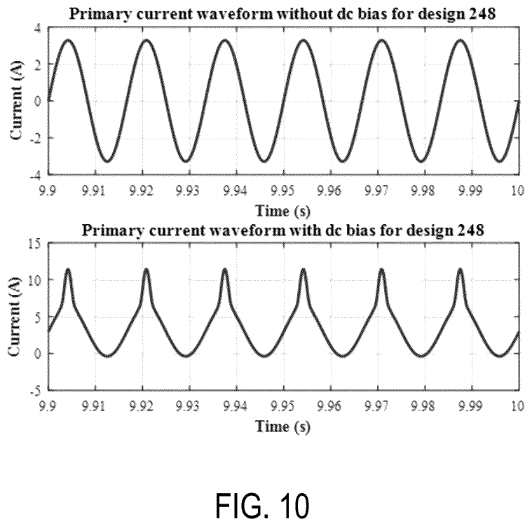

FIG. 10 illustrates the primary current response of the gapped core design 248 with no bias current and with a de bias current of 7 A (the value in the specification). It can be seen that the peak value of the primary current is 19.5 A, which is near the allowed value of 17 A. The reason for the discrepancy may be that the design code is based on a 3D magnetic equivalent circuit, whereas FIG. 10 is based on a 2D FEA. In the next section, an alternate transformer design is considered which addresses the de bias resiliency while maintaining a high magnetizing inductance.

### Impact of DC Bias Immunity on Transformer Design-Modified Core Configuration

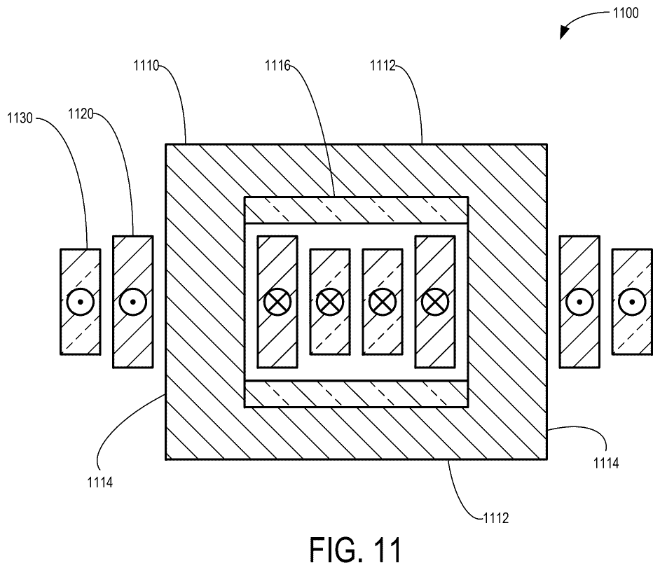

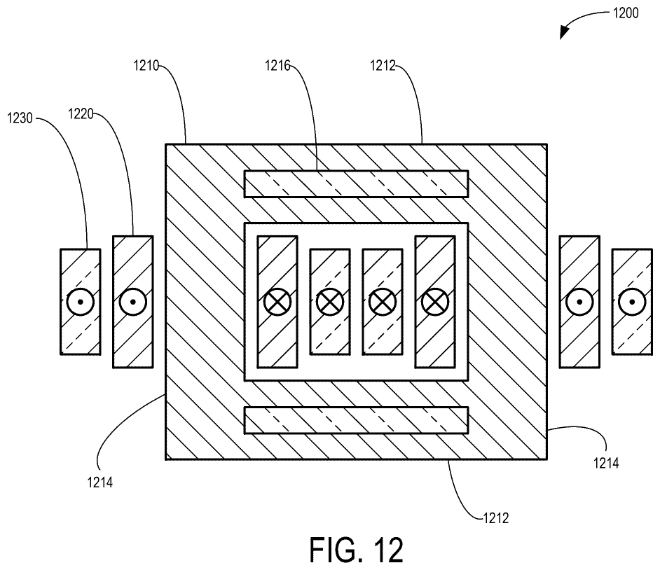

Here, alternate transformer topologies are considered which offer improved dc bias immunity compared to the transformers 200 and 700. FIGS. 11 and 12 illustrate two such design architectures. In each case, the transformer core is made up of two different materials. One of these materials is the high permeability transformer steel and the other is a low relative permeability material. The idea behind these architectures is that, upon saturation of the high permeability transformer steel, the low permeability material will share the flux with the high permeability steel, thereby reducing the adverse effects of half-cycle saturation. Herein, the terms “high permeability” and “low permeability” are used relative to one another. As such, the high permeability material is a material that has a higher permeability than the lower permeability material, and the low permeability material is a material that has a lower permeability than the high permeability material.

Generally, a single-phase transformer in accordance with the present disclosure may have a core including a first horizontal yoke, a second horizontal yoke, a first vertical leg extending from the first horizontal yoke to the second horizontal yoke, and a second vertical leg extending from the first horizontal yoke to the second horizontal yoke; a secondary winding wrapped around the first vertical leg and/or the second vertical leg; and a primary winding wrapped around the secondary winding, wherein the core includes a first portion formed of a first material having a first permeability and a second portion formed of a second material having a second permeability, wherein the second permeability is lower than the first permeability.

FIG. 11 illustrates an interior core window architecture. In particular, FIG. 11 illustrates a transformer 1100 that includes a core 1110 comprising two horizontal yokes 1112 and two vertical legs 1114, wherein a low permeability material 1116 is disposed along an inner surface portion of each yoke 1112. A secondary winding 1120 is wrapped around each leg 1114 of the core 1110, and a primary winding 1130 is wrapped around the secondary winding 1120.

FIG. 12 illustrates an embedded interior core architecture. In particular, FIG. 12 illustrates a transformer 1200 that includes a core 1210 comprising two horizontal yokes 1212 and two vertical legs 1214, wherein a low permeability material 1216 is embedded within each yoke 1212. A secondary winding 1220 is wrapped around each leg 1214 of the core 1210, and a primary winding 1230 is wrapped around the secondary winding 1220. While FIG. 12 illustrates the low permeability material 1216 being embedded only within the yokes 1212, in some implementations the low permeability material 1216 may also be embedded within each leg 1214, such that the low permeability material 1216 has both horizontal and vertical elements to surround the window. However, implementations with both horizontal and vertical elements may provide resiliency to dc bias with greater mass and greater loss compared to implementations with horizontal elements only.

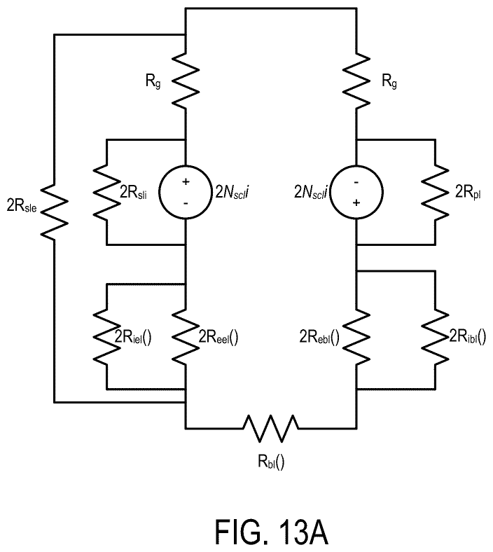

Both architectures are within the scope of the present disclosure. First, the effects of the low permeability material may be explained with reference to the window core architecture as shown in the transformer 1100 of FIG. 11. The magnetic equivalent circuit for the transformer 1100 is illustrated in FIG. 13A. Therein, the base of the transformer has been split into multiple reluctances to represent the flux paths accurately. The expressions for the additional reluctances are given by the following expressions (16)-(19).

$${R}_{ebl} ( Φ ) = \frac{2 {w}_{ice} + {w}_{ece} + {w}_{cs}}{{l}_{cc} {w}_{ecb} {μ}_{B} ( \frac{Φ}{{l}_{cc} {w}_{ecb}} )} \qquad ( 16 )$$

$${R}_{ibl} ( Φ ) = \frac{{w}_{ice} + {w}_{cs}}{{l}_{cc} {w}_{icb} {μ}_{B} ( \frac{Φ}{{l}_{cc} {w}_{ecb}} )} \qquad ( 17 )$$

$${R}_{eel} ( Φ ) = \frac{2 {w}_{icb} + {w}_{ecb} + {d}_{cs}}{{l}_{cc} {w}_{ice} {μ}_{B} ( \frac{Φ}{{l}_{cc} {w}_{ece}} )} \qquad ( 18 )$$

$${R}_{iel} ( Φ ) = \frac{{w}_{icb} + {d}_{cs}}{{l}_{cc} {w}_{ice} {μ}_{B} ( \frac{Φ}{{l}_{cc} {w}_{ice}} )} \qquad ( 19 )$$

In expressions (16)-(19), the function μ_{B}( ) describes the permeability as a function of flux density, the subscript ic refers to the inner (low permeability) core, the subscript e refers to the endleg of the transformer 1100, and the subscript b refers to the baseleg of the transformer 1100.

Similarly, the effects of the low permeability material may be explained with reference to the embedded core architecture as shown in transformer 1200 of FIG. 12. In some examples, the transformer 1200 may pass less flux through its windings under saturated conditions as compared to the transformer 1100. The magnetic equivalent circuit for the transformer 1200 is illustrated in FIG. 13B. Therein, the base of the transformer has been split into multiple reluctances to represent the flux paths accurately. The expressions for the additional reluctances are given by the following expressions (20)-(25).

$${R}_{blll} ( Φ ) = {R}_{bllr} ( Φ ) = \frac{0.5 ( {w}_{cs} - {w}_{blm} + {w}_{ce} )}{0.5 {l}_{cc} ( {w}_{cb} - {h}_{blm} ) {μ}_{B} ( \frac{Φ}{0.5 {l}_{cc} ( {w}_{cb} - {h}_{blm} )} )} \qquad ( 20 )$$

$${R}_{blul} ( Φ ) = {R}_{blur} ( Φ ) = \frac{0.5 ( {w}_{cs} - {w}_{blm} + {w}_{ce} )}{0.5 {l}_{cc} ( {w}_{cb} - {h}_{blm} ) {μ}_{B} ( \frac{Φ}{0.5 {l}_{cc} ( {w}_{cb} - {h}_{blm} )} )} \qquad ( 21 )$$

$${R}_{bllm} ( Φ ) = {R}_{blum} ( Φ ) = \frac{{w}_{blm}}{0.5 {l}_{cc} ( {w}_{cb} - {h}_{blm} ) {μ}_{B} ( \frac{Φ}{0.5 {l}_{cc} ( {w}_{cb} - {h}_{blm} )} )} \qquad ( 22 )$$

$${R}_{aml} ( Φ ) = {R}_{amr} ( Φ ) = \frac{0.5 ( {w}_{cs} - {w}_{blm} + {w}_{ce} )}{{l}_{cc} {h}_{blm} {μ}_{B} ( \frac{Φ}{{l}_{cc} {h}_{blm}} )} \qquad ( 23 )$$

$${R}_{amm} ( Φ ) = \frac{{w}_{blm}}{{l}_{cc} {h}_{blm} {μ}_{B} ( \frac{Φ}{{l}_{cc} {h}_{blm}} )} \qquad ( 24 )$$

$${R}_{ell} ( Φ ) = {R}_{elu} ( Φ ) = \frac{0.25 ( {w}_{cb} + {w}_{blm} )}{{l}_{cc} {w}_{ce} {μ}_{B} ( \frac{Φ}{{l}_{cc} {w}_{ce}} )} \qquad ( 25 )$$

In expressions (20)-(25), the function up ( ) describes the permeability as a function of flux density.

The low permeability material 1116 or 1216 may be selected from three example materials. The first is air. The second is a CoFe/epoxy composite with an initial relative permeability of 20. This material is readily put into the main core and allowed to cure. The third material is generic and assumed to have a selectable value of relative permeability. This was done to obtain guidance into other materials that might be appropriate. To this end, the relative permeability of the generic material is a design parameter allowed to vary between 20 and 100 in design studies conducted to illustrate various examples, though a larger range may fall within the scope of the present disclosure.

The design studies are identical to the studies described above with regard to the gapped core architecture, except for the following differences. First, two additional design variables relating to the dimensions of the low permeability core have been included. These are the ratio of the width of the low permeability core, w_{blm}, to the width of the transformer window and the ratio of the height of the low permeability core, h_{blm}, to the height of the transformer base-leg as shown in expressions (26) and (27). The value of r_{w} is allowed to vary between 0 and 1, and rₕ is allowed to vary between 0.02 and 1.

$${r}_{w} = \frac{{w}_{blm}}{{w}_{cs}} \qquad ( 26 )$$

$${r}_{h} = \frac{{h}_{blm}}{{w}_{cb}} \qquad ( 27 )$$

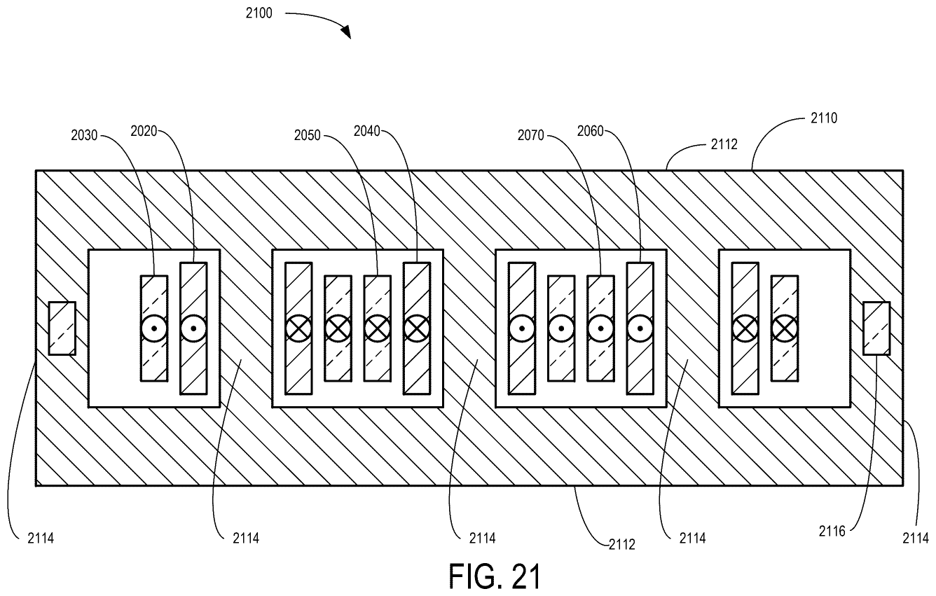

Second, the no-load primary rms current is limited to 2.5% of its full load value. This constraint results in designs which have low magnetizing current and hence improves the no-load power factor of the transformer. This constraint was not included in the comparative example study since the resulting designs already satisfied this constraint. This was not the case with the gapped core design study which resulted in a high no-load magnetizing current. It was found that enforcing this constraint in the gapped core study resulted in no viable designs. An example of a design algorithm used to generate the designs illustrated in FIGS. 11 and 12 is shown in FIG. 22 and described in more detail below.

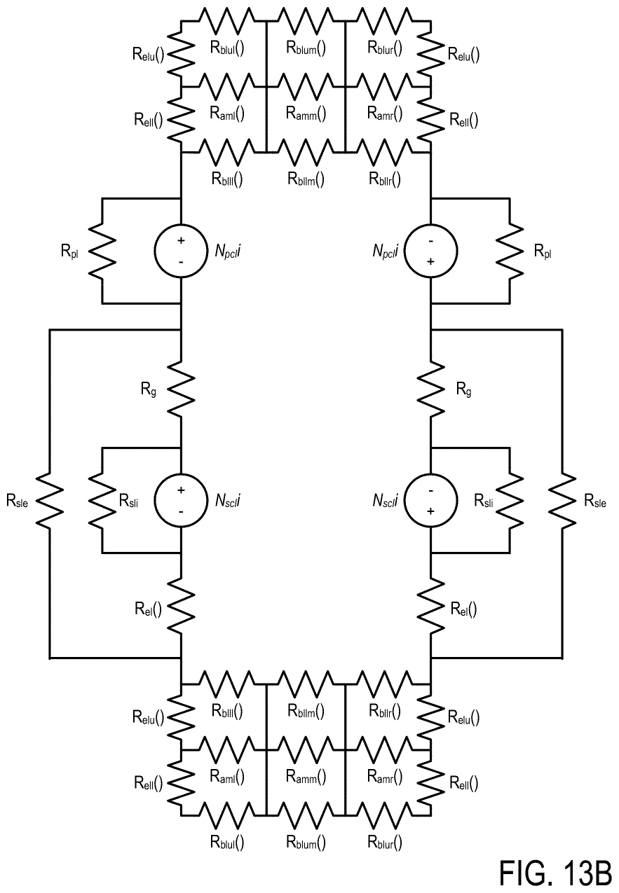

FIG. 14 shows the pareto front comparing the results of the three design studies. From FIG. 14, the designs with CoFe/epoxy composite (trace 1430) coincide with many of the designs from the variable relative permeability study (trace 1420). These are the designs whose internal core relative permeability is selected to be close to 20. It can also be seen that as the mass decreases the designs for CoFe/epoxy composite study and the variable permeability study do not coincide with each other as closely. This is because the chosen relative permeability of these designs is higher than 20. Furthermore, it can also be seen that the air interior core designs (trace 1410) have a slightly lower power loss as the mass of the transformer increases but suffers from higher power loss at lower transformer mass compared to the corresponding CoFe/epoxy composite and variable permeability designs.

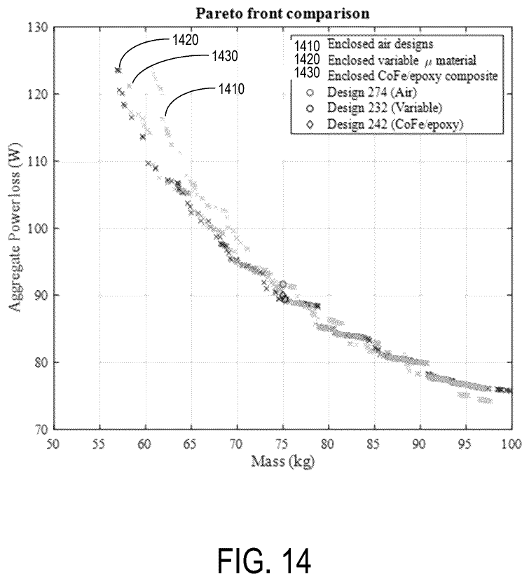

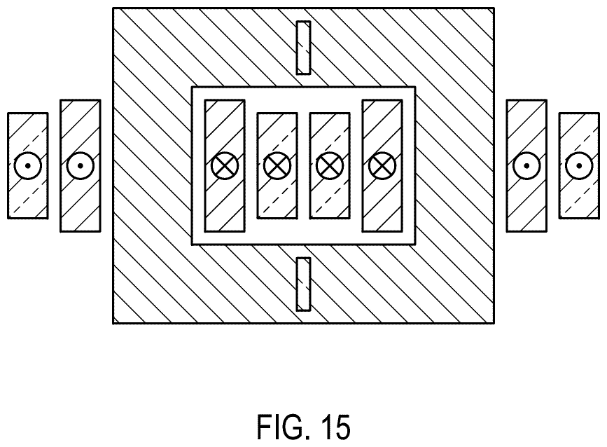

FIG. 15 shows Design 274 from the enclosed air study, which has a width w_{c} (see annotations of FIG. 2) of 0.21 m, a depth dc of 0.31 m, and a length l_{c} of 0.131 m. FIG. 16 shows Design 242 from the enclosed CoFe/epoxy composite study and Design 232 from the variable permeability design study, which have similar structural configurations. Design 242 has a width w_{c} of 0.21 m, a depth d_{c} of 0.28 m, and a length l_{c} of 0.144 m. Design 232 has a width w_{c} of 0.21 m, a depth d_{c} of 0.29 m, and a length l_{c} of 0.136 m. Table 4 provides the selected transformer quantities. The interior air core has the smallest width. This is because of the much smaller relative permeability of air compared to the other interior core materials. The similarity between Designs 242 and 232 is expected from the Pareto front comparison shown in FIG. 14 which shows that the designs around 75 kg are nearly coincident.

TABLE 4
Selected Parameters

| | Value | | | | | |
|---|---|---|---|---|---|---|
| Transformer | Air Core | | Perm. = 20 | | Variable Perm. | |
| Parameter | (Design 274) | | (Design 232) | | (Design 242) | |
| Total mass | 75.0 | kg | 75.0 | kg | 75.2 | kg |
| Encapsulating volume | 9.04 | | 9.18 | | 9.04 | |
| Exterior Core material | M19 | | M19 | | M19 | |
| Interior Core initial μᵣ | 1 | | 20 | | 20 | |
| Length of core (into page) | 13.1 | cm | 14.4 | cm | 13.6 | cm |
| Primary winding wire | 8 | | 14 | | 8 | |
| gauge | | | | | | |
| Primary winding conductor | 1 | | 4 | | 1 | |
| in hand | | | | | | |
| Primary number of turns | 166 | | 159 | | 166 | |
| per coil | | | | | | |
| Primary resistance | 95.6 | mΩ | 99.5 | mΩ | 100 | mΩ |
| Primary leakage inductance | 0.752 | mH | 0.819 | mH | 0.798 | mH |
| Secondary winding wire | 13 | | 12 | | 12 | |
| gauge | | | | | | |
| Secondary winding | 4 | | 4 | | 4 | |
| conductors in hand | | | | | | |
| Secondary number of turns | 94 | | 90 | | 94 | |
| per coil | | | | | | |
| Secondary resistance | 35.1 | mΩ | 28.4 | mΩ | 28.9 | mΩ |
| Secondary leakage | 29.2 | μH | 59.3 | μH | 59.5 | μH |
| inductance | | | | | | |
| No-load magnetizing | 2.40 | H | 2.47 | H | 2.87 | H |
| inductance | | | | | | |
| Transformer regulation | 4.40% | | 4.79% | | 4.73% | |
| No-load magnetizing | 0.267 | A | 0.271 | A | 0.242 | A |
| current (rms) | | | | | | |

| | | | |
|---|---|---|---|
| Half-load efficiency | 97.7% | 97.7% | 97.7% |
| Full-load efficiency | 97.2% | 97.3% | 97.3% |

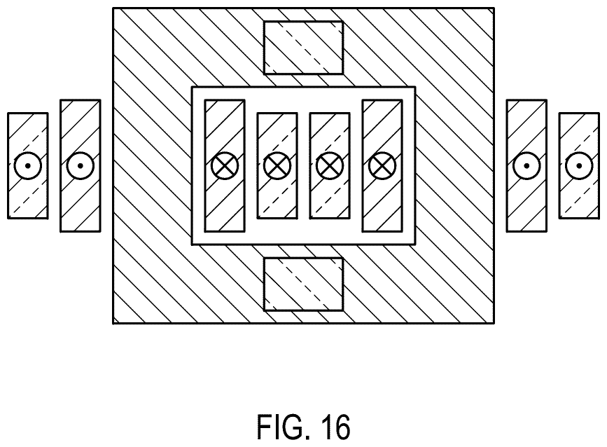

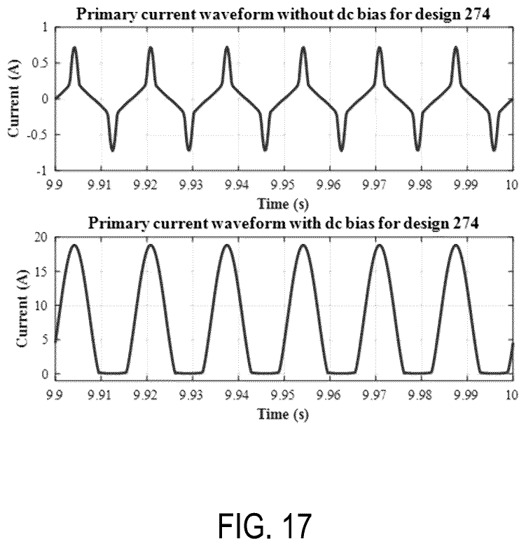

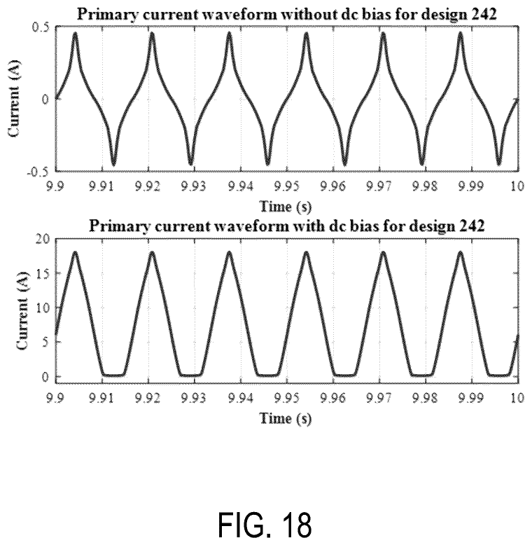

FIGS. 17-19 show the no-load primary winding current for design the voltage excitation which would result in a steady state de current of 7 A to flow in the primary winding. It can be seen from FIG. 17 that the peak of the current waveform is limited to 19.1 A which is close to the maximum allowed value for peak current 17.0 A. As discussed previously, the cause of this discrepancy is the difference between the 3D magnetic equivalent circuit and a 2D finite element analysis in a numerically sensitive situation.

While the transformers 700, 1100, and 1200 are single-phase core-type transformers, as noted above the present disclosure is not so limited. The systems and methods described herein, in which the transformer core includes an area in which a low permeability material is disposed, can also be applied to multi-phase transformers and to other transformer configurations. For example, in a three-phase core-type transformer, an area of low permeability material may be embedded in the horizontal yokes between each leg of the transformer.

While core-type transformers possess a lower core mass for the same power level, occupy lower volume, and provide for easy cooling and maintenance, a five-limb shell-type transformer may be used. One reason for this is that the five-limb transformer has a lower height than the core type transformer facilitating its transportation. Another reason is that the five-limb transformer provides a low reluctance path, via the outermost vertical legs, to the zero-sequence flux under fault conditions. Without the end legs, the zero-sequence flux would complete its path through transformer tank and its adjacent structural members resulting in undesired heating of the tank during unbalanced faults. However, it is this feature of the five-limb transformer that makes it more susceptible to de bias than the core type transformer.

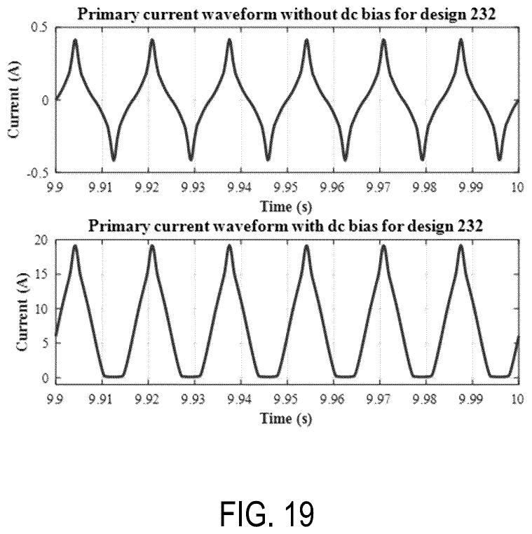

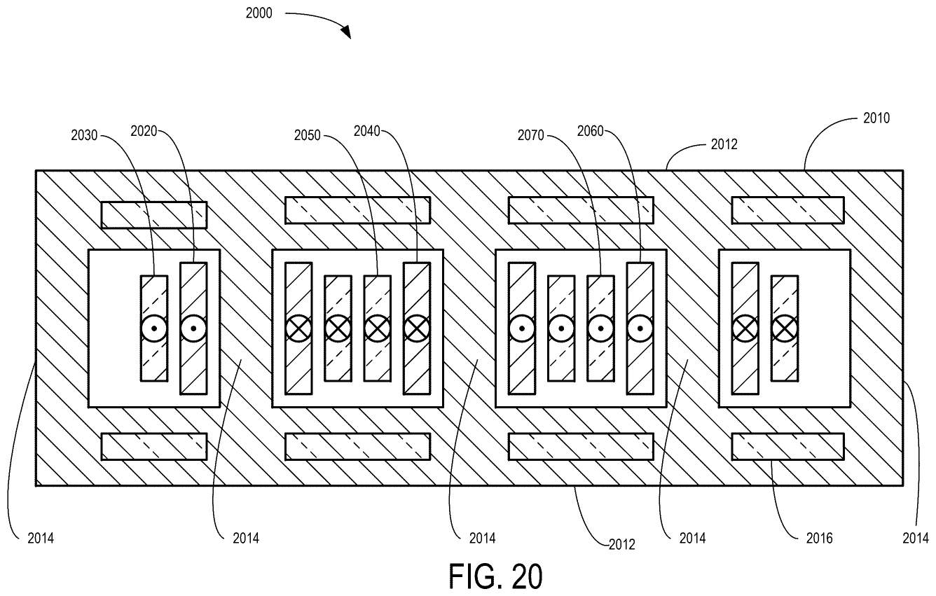

FIGS. 20 and 21 illustrate two examples of a three-phase five-limb transformer architecture in accordance with embedded interior core architecture of the present disclosure. In FIG. 20, a transformer 2000 includes a core 2010 comprising horizontal yokes 2012 and vertical legs 2014. The vertical legs 2014 include two end legs and three interior legs. In the portions of each horizontal yoke 2012 between the vertical legs 2014, a low permeability material 2016 is disposed, extending generally in a horizontal direction (e.g., having a larger dimension in a horizontal direction than in a vertical direction, although if the low permeability material 2016 is air the horizontal dimension may be smaller than the vertical dimension). While FIG. 20 illustrates the end legs as having the same width as interior legs, in practical implementations end and internal vertical legs 2014 may have different widths. For each phase, a pair of windings are wrapped around one of the interior legs: a first-phase secondary coil 2020 is wrapped around one leg with a first-phase primary coil 2030 wrapped around the first-phase secondary coil, a second-phase secondary coil 2040 is wrapped around another leg with a second-phase primary coil 2050 wrapped around the second-phase secondary coil 2040, and a third-phase secondary coil 2060 is wrapped around a third leg with a third-phase primary coil 2070 wrapped around the third-phase secondary coil 2060.

In FIG. 21, a transformer 2100 includes a core 2110 comprising horizontal yokes 2112 and vertical legs 2114. The vertical legs 2114 include two end legs and three interior legs. In both of the end legs, a low permeability material 2116 is disposed, extending generally in a vertical direction (e.g., having a larger dimension in a vertical direction than in a horizontal direction, although if the low permeability material 2116 is air the vertical dimension may be smaller than the horizontal dimension). While FIG. 21 illustrates the end legs as having the same width as the interior legs, in practical implementations end and interior vertical legs 2114 may have different widths. For each phase, a pair of windings are wrapped around one of the interior legs: a first-phase secondary coil 2120 is wrapped around one leg with a first-phase primary coil 2130 wrapped around the first-phase secondary coil, a second-phase secondary coil 2140 is wrapped around another leg with a second-phase primary coil 2150 wrapped around the second-phase secondary coil 2140, and a third-phase secondary coil 2160 is wrapped around a third leg with a third-phase primary coil 2170 wrapped around the third-phase secondary coil 2160.

Compared to the configuration of FIG. 20, the configuration of FIG. 21 may result in a larger magnetizing inductance while simultaneously reducing the de flux flowing in the transformer core, thus reducing the no-load current being drawn by the transformer 2100.

Thus, generally, a three-phase transformer in accordance with the present disclosure may have a core including a first horizontal yoke, a second horizontal yoke, a first vertical end leg extending from the first horizontal yoke to the second horizontal yoke, a second vertical end leg extending from the first horizontal yoke to the second horizontal yoke, a first vertical interior leg extending from the first horizontal yoke to the second horizontal yoke, a second vertical interior leg extending from the first horizontal yoke to the second horizontal yoke, and a third vertical interior leg extending from the first horizontal yoke to the second horizontal yoke; a first-phase secondary winding wrapped around the first vertical interior leg; a first-phase primary winding wrapped around the first-phase secondary winding; a second-phase secondary winding wrapped around the second vertical interior leg; a second-phase primary winding wrapped around the second-phase secondary winding; a third-phase secondary winding wrapped around the third vertical interior leg; and a third-phase primary winding wrapped around the third-phase secondary winding; wherein the core includes a first portion formed of a first material having a first permeability and a second portion formed of a second material having a second permeability, wherein the second permeability is lower than the first permeability.

The architectures of transformers 2000 and 2100 are also applicable to single-phase transformers, which generally include two end legs a single interior leg. In such implementations, a low permeability material portion may be embedded in each yoke between each end leg and the interior leg, similar to the arrangement shown in FIG. 20, or may be embedded in each end leg, similar to the arrangement shown in FIG. 21.

Moreover, the interior window architecture may be implemented in a single- or multi-phase shell-type transformer, based on the transformer 1100 shown in FIG. 11. In such implementations, a low permeability material portion may be disposed along an inner portion of each yoke or along an inner portion of each end leg, in a similar manner.

FIG. 22 illustrates an example transformer design method 2200 in accordance with various aspects of the present disclosure. The method 2200 is an example of an algorithm that implements the constraints described in detail above, and may be used to determine the design fitness when generating any of the transformers described herein (e.g., the transformers 1100 and/or 1200). At operation 2202, the transformer dimensional parameters are calculated. Then, at operation 2204, it is determined whether the transformer dimensional constraints are satisfied by the dimensional parameters. If so, then at operation 2208, the transformer electrical parameters are calculated. Next, at operation 2210, it is determined whether the regulation constraints are satisfied by the electrical parameters (e.g., whether the regulation is less than 5% as noted above). If so, at operation 2212 the flux linkage at max inrush current is calculated. At operation 2214, it is determined whether the inrush current constraints are satisfied by the max inrush current (e.g., whether the max inrush current is 212 times the rated rms primary current).

If they are, then at operation 2216 the tolerable dc-current is calculated and at operation 2218 it is determined whether the tolerable dc-current satisfies the de current constraints (e.g., whether the dc bias current the transformer can tolerate is less than that determined by expression (11) above; that is, whether the peak primary current under a dc bias condition of 20% of the rated peak primary current is half the rated peak primary current). If the dc current constraints are satisfied, the method 2200 proceeds to operation 2220 wherein the no-load operating characteristics are calculated. Then, at operation 2222 it is determined whether the no-load operating characteristics satisfy the new no-load current constraints (e.g., whether the no-load primary current is less than 2.5% of its full load value). If they are satisfied, then at operation 2224 the half and full load operating characteristics are calculated. If both characteristics are determined to satisfy power loss constraints at operation 2226, then the final fitness is generated at operation 2228. If any of the calculated characteristics (e.g., as calculated by operations 2202, 2208, 2212, 2216, 2220, and/or 2224) are determined not to satisfy the corresponding constraints (e.g., in operations 2204, 2210, 2214, 2218, 2222, and/or 2226), then the method 2200 proceeds to operation 2206 and calculates the corresponding fitness.

While FIG. 22 illustrates the various calculations and determinations as being performed in a particular order, in practical implementations certain calculation/determination pairs may be performed in a different order than that expressly illustrated in FIG. 22 (e.g., operations 2208 and 2210 may be performed after operations 2212 and 2214, and so on).

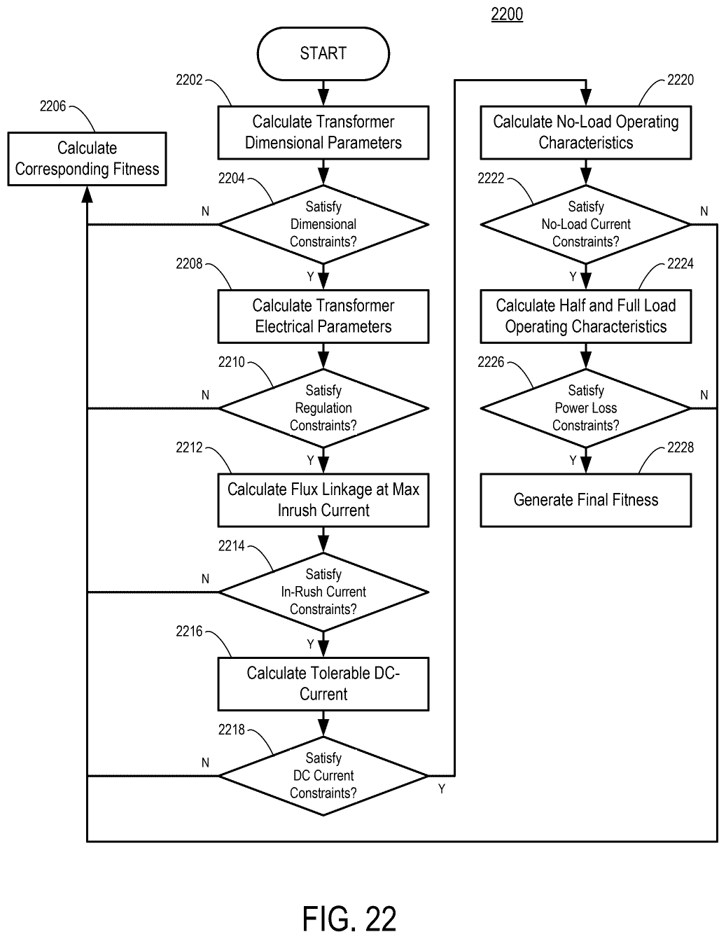

Using the method 2200, a single-phase, 60 Hz, 5 kVA, 208 V to 120 V transformer prototype was designed and constructed. The prototype was subjected to an analysis that was similar to the analyses performed above for the transformers 200 and 700. FIG. 23 illustrates the performance of the prototype under an example test. In this test, the prototype was subjected to different levels of dc bias current at rated primary voltage at rated load. The dc bias current was varied from 0 to 15 A. The primary voltage, the primary current, and the secondary voltage were recorded and are illustrated in FIG. 23. In FIG. 23, the top trace depicts the primary current, which can be seen to have a very heavy dc bias; the middle trace depicts the primary voltage, which looks similar to the comparative case; and the lower trace depicts the secondary voltage, which also looks similar to the comparative case. It can be seen that the no-load primary current under the rated dc bias is close to the rated peak value of 17 A.

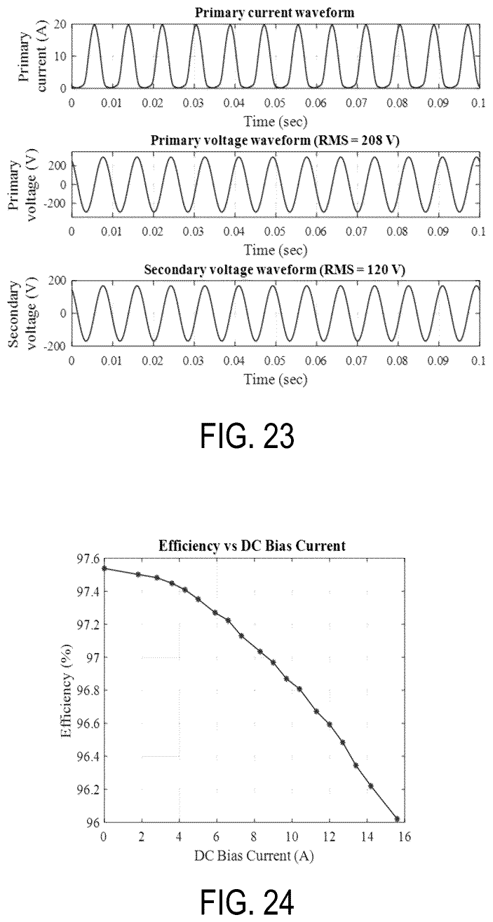

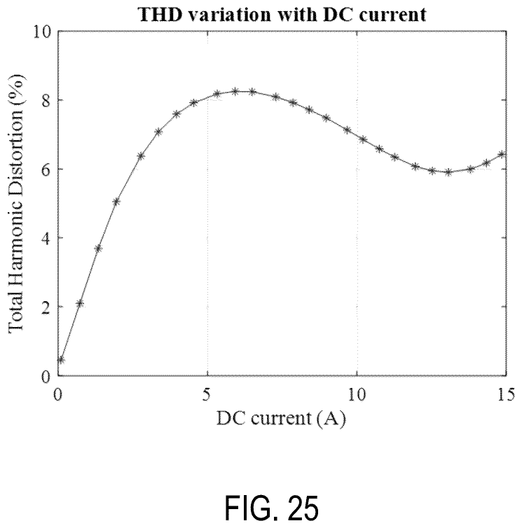

The full load efficiency of the prototype versus dc bias is shown in FIG. 24. The increase of losses is evident from the decrease in efficiency, but it is notable that the transformer efficiency drops by only 1.5% even when the dc bias is increased to 15 A (note that the design value was 7 A). This shows that the dc-bias resilient transformer of the present disclosure remains efficient even under dc bias conditions. FIG. 25 shows the variation of the full load primary current total harmonic distortion (THD) with dc bias. It can be seen that the maximum THD occurs at the rated de bias current value of 7 A.

Thus, the present disclosure provides two de current tolerance metrics and provides a dc current tolerant transformer architecture and design methodology. The methodology to calculate the dc current tolerance for a given transformer design and dc bias was found to compare reasonably well to the estimate obtained using time-stepping FEA simulation. It was shown that designing transformers with a low permeability internal core region significantly increased the transformer resiliency with respect to de currents. No new transformer parts (e.g., additional sources, circuit breakers, auxiliary windings, controllable sources, compensation windings, or negative magnetic reluctance structure) are required. Only a modification of the core is needed, which may result in at most a modest increase in cost using the approaches described above.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A transformer, comprising:
a core including a first horizontal yoke, a second horizontal yoke, a first vertical leg extending from the first horizontal yoke to the second horizontal yoke, and a second vertical leg extending from the first horizontal yoke to the second horizontal yoke;
a secondary winding wrapped around at least one of the first vertical leg or the second vertical leg; and
a primary winding wrapped around the secondary winding,
wherein the core includes a first portion formed of a first material having a first permeability and a second portion formed of a second material having a second permeability, wherein the second permeability is lower than the first permeability.

2. The transformer of claim 1, wherein the second material is embedded in the first horizontal yoke and in the second horizontal yoke.

3. The transformer of claim 2, wherein the first material is a steel, and the second material is air, a cobalt-iron/epoxy composite, or another material having a permeability less than that of the first material.

4. The transformer of claim 2, wherein a width of the second portion is less than a distance between the first vertical leg and the second vertical leg.

5. The transformer of claim 2, wherein a height of the second portion is less than a height of the horizontal yoke.

6. The transformer of claim 2, wherein the second material is air, and a width of the second portion is less than a height of the second portion.

7. The transformer of claim 1, wherein a no-load primary rms current of the transformer is less than or equal to a predetermined threshold.

8. The transformer of claim 1, wherein a peak current of the primary winding under a predetermined dc bias condition is less than or equal to a predetermined value.

9. The transformer of claim 1, wherein the second material is disposed along an inner surface of the first horizontal yoke and an inner surface of the second horizontal yoke.

10. The transformer of claim 9, wherein the first material is a steel, and the second material is a cobalt-iron/epoxy composite or a material having a permeability less than the first material.

11. A three-phase transformer, comprising:
a core including a first horizontal yoke, a second horizontal yoke, a first vertical end leg extending from the first horizontal yoke to the second horizontal yoke, a second vertical end leg extending from the first horizontal yoke to the second horizontal yoke, a first vertical interior leg extending from the first horizontal yoke to the second horizontal yoke, a second vertical interior leg extending from the first horizontal yoke to the second horizontal yoke, and a third vertical interior leg extending from the first horizontal yoke to the second horizontal yoke;
a first-phase secondary winding wrapped around the first vertical interior leg;
a first-phase primary winding wrapped around the first-phase secondary winding;
a second-phase secondary winding wrapped around the second vertical interior leg;
a second-phase primary winding wrapped around the second-phase secondary winding;
a third-phase secondary winding wrapped around the third vertical interior leg; and
a third-phase primary winding wrapped around the third-phase secondary winding;
wherein the core includes a first portion formed of a first material having a first permeability and a second portion formed of a second material having a second permeability, wherein the second permeability is lower than the first permeability.

12. The three-phase transformer of claim 11, wherein the second material is embedded in the first horizontal yoke and in the second horizontal yoke at a first position between the first vertical end leg and the first vertical interior leg, at a second position between the first vertical interior leg and the second vertical interior leg, at a third position between the second vertical interior leg and the third vertical interior leg, and at a fourth position between the third vertical interior leg and the second vertical end leg.

13. The three-phase transformer of claim 12, wherein the first material is a steel, and the second material is air, a cobalt-iron/epoxy composite, or another material having a permeability less than that of the first material.

14. The three-phase transformer of claim 12, wherein a width of the second portion at the second position is less than a distance between the first vertical interior leg and the second vertical interior leg.

15. The three-phase transformer of claim 12, wherein a height of the second portion at the second position is less than a height of the horizontal yoke.

16. The three-phase transformer of claim 12, wherein a width of the second portion is greater than a height of the second portion.

17. The three-phase transformer of claim 11, wherein a no-load primary rms current of the transformer is less than or equal to a predetermined threshold.

18. The three-phase transformer of claim 11, wherein a peak current of the first-phase primary winding under a predetermined de bias condition is equal to a predetermined value.

19. The three-phase transformer of claim 11, wherein the second material is embedded at a first position in the first vertical end leg and at a second position in the second vertical end leg.

20. The three-phase transformer of claim 19, wherein a width of the second material at the first position is less than a height of the second material at the first position.
